(19) United States
(12) Patent Application Publication
(10) Pub. No.: US 2021/0109603 A1
(43) Pub. Date: Apr. 15, 2021

(54) DYNAMIC BUTTON ASSEMBLY

(71) Applicant: SUZOHAPP AMERICAS LLC, Mount Prospect, IL (US)

(72) Inventors: Pierre Hagop KEYLIAN, Henderson, NV (US); Anthony Michael JEFFS, Las Vegas, NV (US)

(73) Assignee: SUZOHAPP AMERICAS LLC, Mount Prospect, IL (US)

(21) Appl. No.: 17/066,216

(22) Filed: Oct. 8, 2020

Related U.S. Application Data
(60) Provisional application No. 62/912,905, filed on Oct. 9, 2019.

(51) Int. Cl. G06F 3/02; G06F 3/044; G06F 3/0338

(52) U.S. Cl. CPC G06F 3/0202; G06F 3/0338; G06F 3/044

(57) ABSTRACT

A dynamic button assembly for use in interactive display devices, such as gaming, amusement, or vending machines. The dynamic button assembly may be configured in such a way that the button sides are illuminated. The dynamic button assembly may be further configured in a way that allows images to be projected into the top portion of the button that are visible to a user without causing image distortion. The configuration of the dynamic button assembly allows the underlying touch sensitive screen and display panel to extend continuously underneath the button assembly. Conductive inserts in the dynamic button assembly allow the machine to which the button is attached to identify the placement and functionality of the button. The button assembly may be configured as a multi-directional joystick or be configured to register button rotation as a rotational controller.

### CROSS REFERENCE TO RELATED APPLICATIONS

The present application relates and claims priority to: U.S. Provisional Patent Application No. 62/912,905, entitled “Dynamic Button Assembly,” filed Oct. 9, 2019. The disclosure of the above-referenced application is hereby incorporated by reference.

### FIELD OF THE INVENTION

This invention is directed to dynamic button assemblies that provide user interactions with display devices, such as gaming or amusement machines, vending machines, or car wash machines. In particular, the invention is directed towards button assemblies that are mounted to a display element allowing the display element to extend continuously under the mounted button assembly and be visible though the body of the button. The button assembly can also include transparent or translucent edges to allow illumination of the button by the underlying display element without allowing light spillage to the surrounding areas of the button assembly.

### BACKGROUND OF THE INVENTION

In the industries using interactive displays, such as the gaming and amusement industries, many different types of mechanisms allow users to make selections, often through push buttons. These push buttons are typically connected to sensors or switches that are integrated into the overall gaming machine or amusement machine, and provide an indication that the user has made a particular selection, with the processing circuitry then converting the indicated user selection into a new visual display.

Currently, there are several types of push button mechanisms available. These push button mechanisms include sub-miniature micro switches, transmissive or reflective photo micro sensors, reed switches, Hall Effect switches, carbon pill switches, and dome switches. Some of these require openings, or holes on the surface of the machine to connect the button mechanism to the machine, and others require magnets or other components to be housed within or placed above the top of the button. Moreover, many of these existing button designs require additional liquid ingress protection to prevent liquids entering and damaging the machine. Current push button mechanisms that require a hole through the surface of the machine may also require electro-static discharge (“ESD”) protection to dissipate electrical charges, which may interfere with the function of the button mechanism or the machine. Additionally, current button mechanisms may require a cable or other means to connect button lighting and actuation control to the machine, which may be aesthetically displeasing. Existing button mechanisms may also require a space below the surface of the button for additional components. Such a design prevents the display of images on the face of the button from an underlying display panel, causing “tunnel vision,” which is the appearance of displayed graphics below the surface of the panel that the button is mounted to.

What is needed is a button mechanism that can be placed on a touch sensitive surface of a machine, allowing a user actuating the button to actuate the touch circuitry directly, without the need for additional switch components within the button. Further, a button mechanism is needed that is movable and can be placed on any touch sensitive surface of the machine to which it is attached.

### SUMMARY OF THE INVENTION

The present invention is directed to a dynamic button assembly that provides user interaction with a display device having a touch sensitive screen or element, such as in gaming and amusement machines, vending machines, or car wash machines. The button assembly may act as a switch-type input, registering activations by a user. The button assembly may be further configured in a way that allows the button assembly to act as a multi-directional controller or rotational controller. The dynamic button assembly is mounted above a touch sensitive screen on the machine or display device, such that activation of the button is registered on the touch sensitive screen. For example, the dynamic button assembly may be mounted on top of a transparent surface of a machine or display device, and touch sensitive element such as a Projective Capacitive Touch Sensor (“PCAP sensor”) may be mounted to the underside of the transparent surface. Together, the touch sensitive element and transparent surface may be referred to as a “touch screen.” A display panel or element, such as a liquid crystal display (“LCD”), may underlie the touch screen. When the button assembly is activated, such as by being pushed or depressed by a user, the touch screen registers the activation of the button and transmits an appropriate signal to a processor within the display device. The button assembly may be mounted to the display device above the touch screen such that the transparent surface and the underlying display panel extend continuously under the button assembly. The button assembly may be mounted to the transparent surface of the touch screen in any location where it overlaps the underlying touch sensitive element.

The button assembly may include a transparent top surface, such that images or other visuals may be projected from the display screen or element through the top of the button assembly. For example, the top surface of the button may be a lens element. This allows for images or other visuals projected by the underling display panel element to be visible to a user in the area of the button assembly without causing distortion of the image. Images may also be projected through the top surface of the button lens by securing an artwork layer within the button assembly, which is then backlit by the display panel or element. Further, the button assembly may be configured with a top surface having a transparent or translucent bezel, allowing the button assembly to be illuminated via an underlying display element. The underlying display element may be configured in a way to prevent light spillage to the surrounding area of the underlying display element.

### BRIEF DESCRIPTION OF THE DRAWINGS

FIG. 1A illustrates an example of a dynamic button assembly.

FIG. 1B provides an exploded view of FIG. 1 demonstrating the mounting of the dynamic button assembly to a touch screen surface panel.

FIG. 2 illustrates a side view of the dynamic button assembly, and the proximity of the top of the dynamic button assembly to the surface panel.

FIG. 3 illustrates a cross-sectional side view showing the components of the dynamic button assembly.

FIG. 4A illustrates a magnified cross-sectional side view of the dynamic button assembly of FIG. 3, showing the button in a resting position.

FIG. 4B illustrates a magnified cross-sectional side view of the dynamic button assembly of FIG. 3, showing the button in a depressed position.

### DETAILED DESCRIPTION

The present invention is directed to dynamic button assemblies for use with display devices having touch sensitive screens. Multiple dynamic button assemblies may be mounted to one or more touch screens located on or connected to a display device, allowing a user to provide one or more commands to the device. The button assembly may be configured as a standard button with a single actuation area, or may be configured as a multi-directional joystick having multiple actuation areas around the periphery of the button assembly, which enables different commands to be configured to specific areas of the button assembly. The dynamic button assembly may also be configured as a rotational controller, wherein actuator insert elements are placed in contact with or in close proximity to the touch screen, allowing the device to register the rotation of the button assembly. The dynamic button assembly may be configured in various shapes and sizes. The touch screen and the underlying display element may also be configured in various sizes and shapes. The dynamic button assembly may be configured with a button lens mounted in bezel elements to allow the underlying display element to display visual images through the button. Further, the dynamic button assembly may have a transparent or translucent button bezel to allow light from the underlying display element to illuminate the button assembly. Further, the dynamic button assembly may be configured with underlying physical artwork that may be illuminated by the underlying display panel.

The dynamic button assembly may include one or more conductive actuator inserts configured to move from a rest position to a depressed position when the button is pressed. When the button is pressed, the conductive actuator inserts move from the rest position and come into contact with, or close proximity to, the touch screen. Movement of the actuator inserts from a rest position to a rotated position may also be sensed by the touch screen. In response to an actuation of the button, the touch screen then provides a signal representing the actuation to a controller or processor in the device. The dynamic button assembly allows a user to interact with the device by providing inputs, issuing commands, or making selections through pushing, rotating, or otherwise activating the button assembly. The distance or amount of depression or rotation, time of depression or rotation, or speed of depression or rotation may be recognized by the touch screen to provide different output signals. The display device to which the button assembly is attached to may allocate different commands to these different output signals. Moreover, when a plurality of dynamic button assemblies are attached to the display device, each button may be configured to issue a particular type of command. Alternatively, each of the plurality of buttons may be configured to issue multiple commands depending on user activation.

For button assemblies mounted to touch screens having a PCAP capacitive grid, a button lens may be coated with an iridium tin oxide (“ITO”) layer that, in conjunction with conductive actuator inserts in the button assembly, allow the PCAP touch screen to register an actuation of the button assembly by depressing the button assembly such that the actuators come into contact with, or close proximity to, the touch screen. Without the ITO layer, the conductive actuator inserts themselves may not cause a large enough change in capacitance to be effectively registered by the touch screen. That is, when a user touches the button lens to actuate the button assembly, the ITO layer transmits the conductive recognition of the user's touch to the conductive actuator inserts, thereby amplifying the change in capacitance such that it can be registered by the touch screen. The PCAP sensitivity and capacitance of the capacitive grid may be adjusted by a touch circuit controller to enable the sensing of different types of depressions by a user. The PCAP capacitive grid may be calibrated to the human body such that changes in the capacitance due to touching by a user are recognized. The dynamic button assembly may be mounted directly to a device, or can be mounted to a remote control having a touch sensitive element that is connected to or in communication with the device.

As mentioned, the dynamic button assembly may be mounted above a touch screen and may include conductive actuator inserts that are recognized by the touch screen providing signals to a processor or controller in the device indicating the presence of the button assembly. For example, the button assembly may include actuator inserts in a base of the button that contact the touch screen. The actuator inserts may be positioned at predetermined locations, allowing the generated signals from the contacted conductive elements or capacitive grid in the touch screen to provide information identifying the presence of the button, the type of button, the dimensions of the button, and/or the functionality of the button.

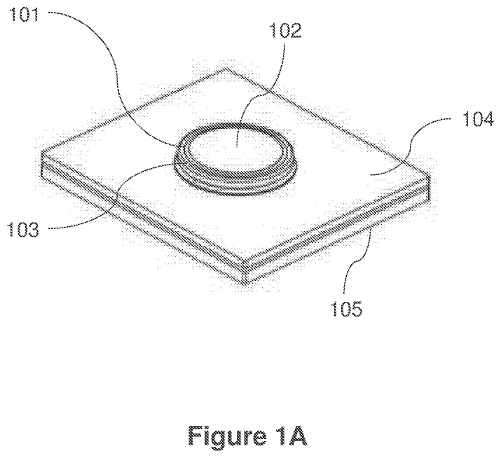

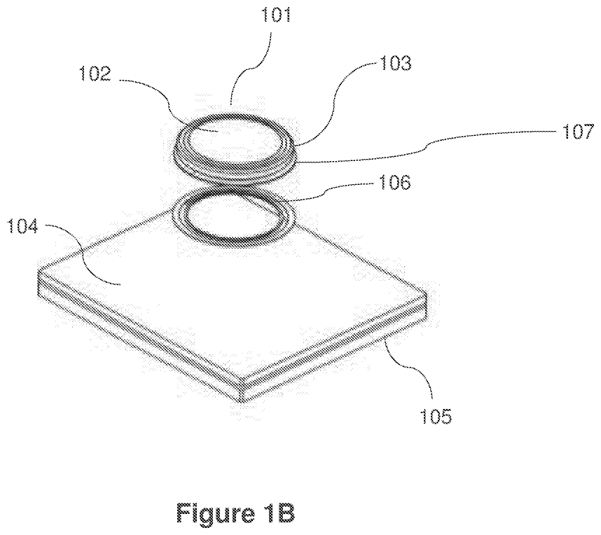

FIG. 1A illustrates an example of a dynamic button assembly. The dynamic button assembly 101 may be depressed, pushed, or rotated by a user to make a selection or input a command to the device containing a touch screen 104. The touch screen 104 may include a top surface, such as glass or plastic, with one or more touch sensitive elements mounted to the underside of the top surface. A display panel 105, such as an LCD display, may be mounted underneath the touch screen. The touch screen 104 may have a flat, concave, or convex shape. As an example, the touch screen may include a glass or plastic top surface having a PCAP capacitive grid mounted to the underside thereof.

The dynamic button assembly 101 may be various sizes and shapes, including round, oval, triangular, reuleaux triangle, square, rectangle, hexagon, or other regular or irregular polygon. The dynamic button assembly 101 includes a button lens 102 mounted in a top bezel 103. The lens may be comprised of a transparent or translucent material such as glass, polycarbonate, clear acrylic or other plastic materials to allow light or images to shine through it.

As discussed, the top surface of the button lens 102 may be treated with an ITO composition or layer, deposited on the surface of the button lens 102 as a thin film by physical vapor deposition, electron beam evaporation, or sputter deposition techniques. When the button assembly is depressed by a user, the ITO layer conducts an electrical signal created by the user's touch to one or more actuator inserts housed in the button assembly. The depression causes the actuator inserts to move from rest positions a predetermined distance above the touch screen to actuation positions in contact with, or close proximity to, the touch screen. The touch screen then registers the actuation of the button assembly, and transmits signals representative of the actuator to a controller or processor associated with the display device. ITO compositions have etching capabilities and chemical resistance to moisture. Other conductive materials may also be used as the coating on the surface of the button lens 102, such as aluminum doped zinc oxide, graphene, or conductive polymers such as polyaniline and amorphous indium-zinc oxide.

The display panel 105 may have a flat, concave, or convex shape. The display panel 105 can be an LCD display, LED display, plasma display, or any other type of illuminating display. While user inputs through the button assembly are registered, as discussed above, the touch screen may also extend above the display panel in areas surrounding the button assembly. The touch screen 104 can be configured to register touch input from a user or operator in these areas surrounding the dynamic button assembly 101 as well. The display panel 105 can also be configured to project light patterns and effects into the dynamic button assembly 101, thereby eliminating the cost and implementation of separate LED devices, LED drivers, or USB controls dedicated to illumination of the dynamic button assembly 101.

FIG. 1B provides an exploded view of the dynamic button assembly 101 illustrating the components of the dynamic button assembly 101 and the mounting of the dynamic button assembly 101 to the touch screen 104. The dynamic button assembly 101 may be permanently mounted to the touch screen 104 or mounted to the touch screen 104 in a way that is removable. Permanent mounting of the button assembly may be achieved by using a glue or epoxy. The dynamic button assembly 101 may be removably mounted using double-sided clear tape 106, such as VHB clear tape. The dynamic button assembly 101 may also be removably mounted using other connectors or fasteners, such as magnets, suction, or non-permanent adhesives. Using a clear adhesive such as the VHB clear tape to mount the dynamic button assembly allows the light or visual images from the underlying display panel 105 to pass into the button assembly with minimal or no distortion.

The mounting of the dynamic button assembly 101 to the touch screen 104 allows for the touch screen 104 and/or display panel 105 to extend continuously under the dynamic button assembly 101. This design obviates the need for holes in the surface of the touch screen 104 and display panel 105, protecting the device to which the button is attached from liquid ingress or potentially interfering stray electrical charges. The dynamic button assembly 101 can be mounted to any device having a touch screen 104. As an example, the dynamic button assembly 101 can be mounted to the main display or separate control area of a machine. Further, the dynamic button assembly 101 can be mounted to a remote control having a touch screen 104 that is connected to or in communication with the main display device. In a gaming machine, for example, a user may interact with a smaller touch screen 104 having the dynamic button assembly 101 mounted thereon as a controller, while a separate, larger screen displays video or other visual images.

As shown in FIG. 1B, the dynamic button assembly 101 further contains a top bezel 103 and a bottom bezel 107, with the top bezel 103 being movable with respect to the bottom bezel 107. The top bezel 103 and the bottom bezel 107 may be comprised of a transparent or translucent material such as glass, polycarbonate, clear acrylic, or other plastic materials to allow light or images to shine through the bezels. The button lens 102 may be connected to the top bezel 103, such that depression of the button lens 102 causes both the button lens 102 and top bezel 103 to move in relation to the bottom bezel 107. In particular, the top bezel may move from a rest position to a depressed position when activated by a user. When a user releases the depression of the button, springs, opposing magnets, or other return mechanisms in the button assembly cause the top bezel 103 and button lens 102 to return to the rest position. The return mechanisms may be of various shapes and sizes, and be located in various areas of the top bezel 103 and bottom bezel 107.

The bottom bezel 107 may be configured to provide liquid ingress protection, through strategically placed channels and conduits to direct the flow of any liquid that may make its way into the button assembly away from the interior of the button assembly. For example, each dynamic button assembly 101 may include one or more liquid channels and outlets, directing any liquid which may ingress into the assembly through the channels and outlets.

The display panel 105 can illuminate the top bezel 103 by transmitting light through the touch screen 104 and into the top bezel 103. The light transmitted by the display panel 105 and into the top bezel 103 can produce a halo effect around the perimeter of the dynamic button assembly 101, and can illuminate the top bezel 103. Specifically, the pixels of the display panel 105 can be matched to the top bezel 103 in order to provide adequate lighting of the top bezel 103 without causing inordinate light spillage due to refraction in the area of the touch screen 104 surrounding the dynamic button assembly 101, which can affect adjacent image content.

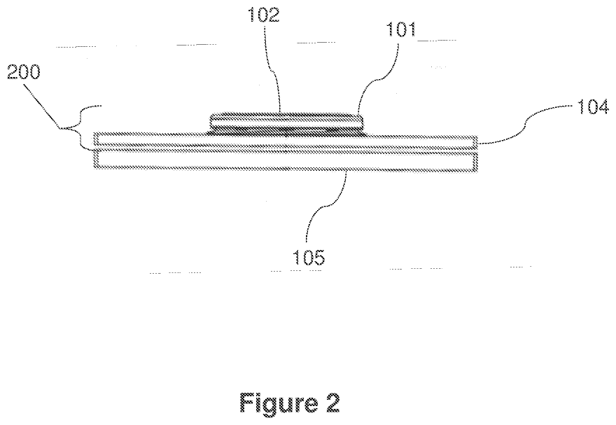

FIG. 2 provides a side view of a button assembly 101 mounted to the surface of a touch screen 104, with a display panel 105 underling the touch screen. As shown, the proximity of the button lens 102 to the display panel 105 200 allows images projected by the display panel 105 to be clearly seen by a user through the button lens 102, reducing the effects of tunneling and parallax error of the images.

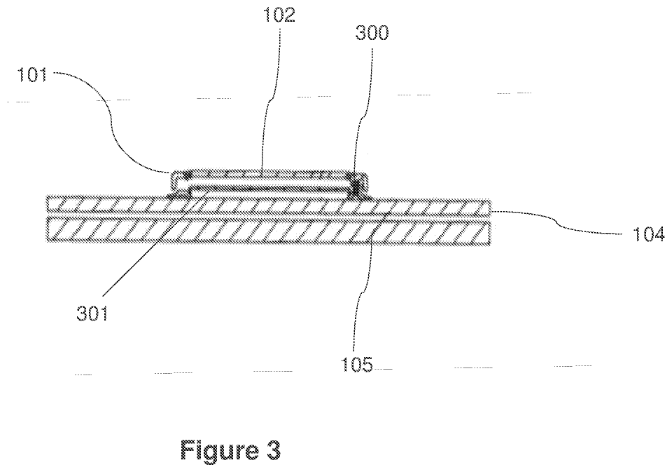

FIG. 3 illustrates a cross-sectional side view showing the components of the dynamic button assembly 101 mounted to a touch screen 104. As discussed, the dynamic button assembly 101 contains one or more conductive actuator inserts 300. The actuator inserts 300 may be a magnetic element or electrically conductive element capable of holding a charge. The actuator inserts 300 may further be comprised of rubber, graphite filled rubber, carbon filled rubber, aluminum foil, chrome plate, or stainless steel inserts. The actuator inserts 300 may be various shapes and sizes, including round, oval, triangular, reuleaux triangle, square, rectangle, hexagon, or other regular or irregular polygon shapes, depending on the shape of the top bezel 103. As shown in FIG. 3, the actuator insert 300 may be mounted in or otherwise connected to the top bezel 103, such that they move in conjunction with the top bezel. For example, in FIG. 3, one or more actuator inserts 300 may be mounted in a recess of the top bezel 103, under the button lens 102. The actuator insert 300 can be mounted using glue or a recess/press fit. As mentioned, the top bezel 103 may be movable relative to bottom bezel 107 of the button assembly, such that the top bezel 103, actuator elements 300, and button lens 102 move downward when pressed by a user. When the one or more actuator inserts 300 come into contact with, or in close proximity to, the touch screen 104, actuations are registered and signals representing the actuation of the button assembly may be provided to controllers or processors associated with the touch screen or display device. The touch screen 104 may sense the amount, speed, and duration of the depression, and information regarding this sensed information is provided to a controller or processor in the touch screen or display device as inputs or commands. In response, the display device may, for example, change the display or provide additional options to the user or provide commands to a program running on the display device.

A valid actuation may also be registered if the button assembly is configured as a multi-directional joystick. In this configuration, actuator inserts 300 are placed at cardinal points around the periphery of the button assembly. The different actuator inserts 300 can register different actuations in the touch screen 104, providing different commands based on the area of the button assembly depressed by the joystick. When a PCAP touch screen 104 is used, the joystick could be coated in an ITO layer in order to register a valid actuation of the joystick. A valid actuation of the button assembly 101, as discussed, may also be accomplished through the rotation of the button assembly as a rotational controller. In this configuration, a rotational button assembly may be mounted to a touch screen 104. One or more actuator inserts 300 are placed in the rotational button assembly such that they are in close proximity or in contact with the touch screen 104. For example, the actuator inserts may be located in a rotatable bottom bezel, connected to the top bezel such that they are suspended from the top bezel, or connected to a rotatable base or side panel of the button assembly. The touch screen 104 senses the direction, amount, speed, and duration of the rotation and information regarding this sensed information is provided to a controller or processor in the touch screen or display device as inputs or commands. In response, the display device may, for example, change the display or provide additional options to the user. Further, illumination of the top bezel 103 may be changed according to the button lens 102 position, and commands may be configured by the device to prompt the user to use the button as a rotary controller. The rotational button may have an ITO layer. Thereby, when a user touches the button, the actuation would be registered by the touch screen 104, without the user needing to depress the rotational button as the actuator inserts 300 are already in close proximity to or in contact with the touch screen 104. In this configuration, a user may implement one type of registered input by touching the ITO layer but not depressing or rotating the button assembly, while other types of registered inputs could be provided by depressing or rotating the button assembly.

The dynamic button assembly 101 may be configured to display physical artwork or lettering through the button lens 102. The artwork is illuminated by the underlying display panel 105, making it visible to a user through the top of the button assembly. The physical artwork may be comprised of a thin sold material, such as a screen printed with graphics, text, or a combination of both. The physical artwork may be held in place using adhesives, by being installed in a recess in the button, or by being pressed in place and held by an interference fit. Further, the physical artwork may be adhered directly to the underside of the button lens 102. Should the physical artwork need to be modified or changed, this can be accomplished by replacing the button lens 102 with another button lens 102 having different physical artwork. Alternatively, the physical artwork may be adhered to the top surface of an optional inner lens 301. When the physical artwork is adhered to the top surface of the inner lens 301, the physical artwork remains stationary when the button lens 102 is depressed by a user. The physical artwork can be changed by first removing the button lens 102 to reveal the physical artwork adhered to the inner lens 301. The physical artwork can either be manually removed from the inner lens 301, or the inner lens 301 can be replaced with another inner lens 301 with different physical artwork adhered to it. The physical artwork adhered to the inner lens 301 may be the only artwork visible to a user through the button lens 102. In this instance, the underlying display panel 105 provides for the illumination of the physical artwork so it may be visible to a user. Further, physical artwork displayed on the inner lens 301 may only be visible to a user when the artwork is illuminated by the underlying display panel 105. The inclusion of an inner lens 301 in the dynamic button assembly 101 may assist in the service and maintenance of the button as it makes the button easier to clean. Alternatively, the inner lens 301 may not be included in the dynamic button assembly 101, and the physical artwork may be applied directly to the touch screen 104. The ability to remove the button lens 102 from the button assembly further makes the button easier to clean.

The display panel 105 can also be configured to project images, text, or a combination of images and text that appear on the button lens 102. The text projections may be related to game play, such as “start,” “spin,” or “select.” The text projections may also provide gambling odds, game titles or options for user selection, or instructions to the user. Moreover, the graphics may include gaming graphics or icons that correspond to the functionality of the device to which the button is attached. When an inner lens 301 is included, the inner lens may be transparent so that artwork from the display panel is visible through the button lens 102. If physical artwork is adhered to the outer surface of the inner lens 301, the physical artwork may block the image or text projections displayed by the underlying display panel 105 from being visible to a user. Alternatively, if physical artwork is included on the outer surface of the inner lens 301, text and image projections projected by the display panel 105 may be visible through the physical artwork adhered to the inner lens 301.

As discussed, the dynamic button assembly 101 includes one or more actuator inserts 300 that actuate conductive traces or capacitive grids in a touch screen 104. In addition to movement of the one or more actuator inserts 300 being registered as an actuation of the button as described above, the actuator inserts 300 may be sensed upon initial placement on a touch screen or activation of a touch screen before the actuation of the button assembly by a user. One or more actuator inserts 300 may be located individually at specific locations around the top bezel 103, or in recesses in the bottom bezel 107. When the button assembly is attached the touch screen 104 and the touch screen 104 is turned on and active, the actuator inserts 300 may actuate conductive traces or capacitive grids in the touch screen 104, which provide signals indicating the presence of the button assembly on the touch screen 104 and which indicate the location of the button assembly on the touch screen 104. Based on the number and position of actuator inserts 300, information including the dimensions, type, and/or functionality of the button may be determined. By identifying the location and the type of dynamic button assembly 101 placed on the touch screen 104 by sensing the actuator inserts 300, the device may be able to control the underling display panel 105 to display particular images or content underneath the area of the button assembly. For example, the device may control the display panel 105 such that the button is illuminated in a particular color, or has a particular image visible through the top of the button. The display area under the button may be selectively changed, such that the button assembly has a different visualization from the rest of the display panel 105 only at certain times. Moreover, the display panel 105 may provide particular images or visualizations in the area surrounding the button. These may include user prompts or instructions for using the button, or varying visualizations in response to activation of the button assembly 101. The device can also use the underlying display panel 105 to illuminate the button assembly 101, such as by illuminating the top bezel 103, while still allowing a visual image or graphic to be viewable through the button lens 102.

An operator or maintenance technician of the device may move the physical location of the dynamic button assembly 101 to a more optimal area of the device for a user, with the new location of the button assembly being registered by the touch screen 104. The actuator inserts 300 in the dynamic button assembly 101 can also allow the button to be removed from the device and placed on a remote control having a touch screen that is connected to or in communication with the display device, allowing the button to function remotely.

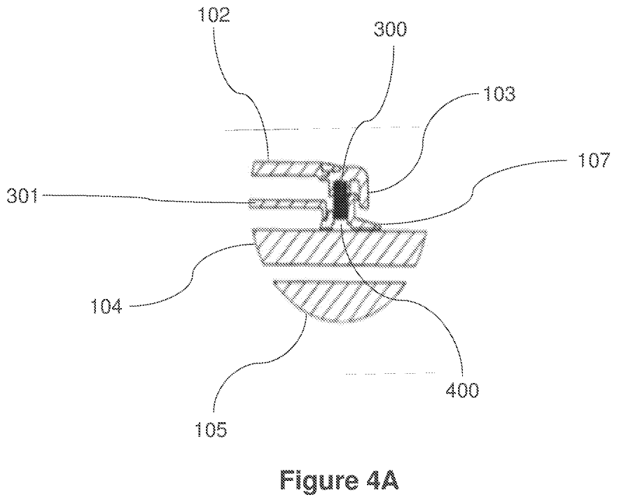

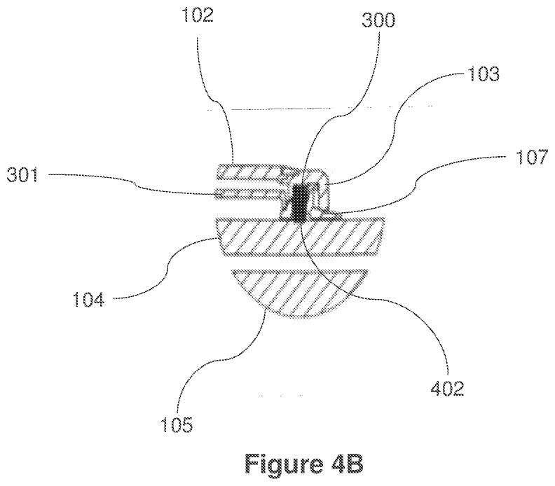

FIG. 4A illustrates a magnified cross-sectional side view of the dynamic button assembly of FIG. 3 showing the button in a resting position 400. FIG. 4B illustrates the dynamic button assembly 101 in a depressed position 402. When the button assembly is in a resting position 400, the actuator insert 300 is positioned a distance away from the touch screen 104 so as to not register a valid actuation. When the user depresses the button assembly, the actuator insert 300 moves to the depressed position 402 where it is in contact with or in close proximity to the touch screen. The touch screen registers this actuation, and may detect the amount, duration, and speed of the depression of the button assembly. The registered actuation may be transformed to input signals or commands from the user, which are recognized by a processor in the touch screen 104 or display device. The touch screen 104 or display device may then take actions in response to the registered input signals or commands. Actuation of the button by the user may be registered as a selection of particular interactive content shown on the display device, a request for new content, a control command in an interactive game, a request to return to a main menu, a request to display options, or a request to end or terminate a currently running interactive display or program. For example, commands from the depression of the button assembly may allow a user to select graphics on a screen in a device, or can include commands to the device such as “start,” “spin,” “change game type,” “change betting odds,” or “select feature.”

1. An interactive display assembly comprising:
a touch sensitive screen;
a display element positioned below the touch sensitive screen; and
at least one dynamic button assembly configured to be mounted to the surface of the touch sensitive screen and comprising:
a button lens;
a top bezel;
a bottom bezel; and
at least one actuation element configured to register a valid actuation in the touch sensitive screen.

2. The interactive display assembly of claim 1, wherein the dynamic button assembly is mounted to a projective capacitive touch sensor.

3. The interactive display assembly of claim 1, wherein the touch sensitive screen is configured to register a valid actuation when the dynamic button assembly is depressed.

4. The interactive display assembly of claim 1, wherein the display panel is configured to project images, patterns, or lighting effects onto the button lens, top button bezel, or bottom button bezel.

5. The interactive display assembly of claim 1, wherein the dynamic button assembly is configured to operate as a multi-directional joystick.

6. The interactive display assembly of claim 1, wherein the dynamic button assembly is configured to operate as a rotational controller.

7. The interactive display assembly of claim 1, wherein the dynamic button assembly is configured to mount to the touch sensitive screen without any holes or openings in the touch sensitive screen to make connections between the dynamic button assembly and the touch sensitive screen.
